(19) United States
(12) Patent Application Publication
(10) Pub. No.: US 2007/0140645 A1
(43) Pub. Date: Jun. 21, 2007

(54) Circuit arrangement and method for generating local oscillator signals, and phase locked loop having the circuit arrangement

(76) Inventors: Stefano Marsili, Furnitz (AT); Christoph Sandner, Villach (AT)

Correspondence Address: ESCHWEILER & ASSOCIATES, LLC;NATIONAL CITY BANK BUILDING, 629 EUCLID AVE., SUITE 1000, CLEVELAND, OH, 44114, US

(21) Appl. No.: 11/605,086

(22) Filed: Nov. 28, 2006

(30) Foreign Application Priority Data
Nov. 29, 2005 (DE) DE102005056952.8

(51) Int. Cl. H04N 9/79

(52) U.S. Cl. 386/23; 375/308; 375/376

(57) ABSTRACT

A circuit arrangement for generating local oscillator signals is supplied with a reference frequency signal by means of a signal input. A frequency divider is used to derive a second signal from the reference frequency signal. The reference frequency signal and the second signal are supplied to a selection device, where one of the signals is output on the basis of a first selection signal. In an auxiliary signal generator, a single auxiliary signal at an auxiliary frequency is generated on the basis of a second selection signal. In a frequency conversion device, a local oscillator signal which can be tapped off on the signal output is derived from the output signals from the selection device and the auxiliary signal generator.

### REFERENCE TO RELATED APPLICATIONS

This application claims the benefit of the priority date of German application DE 10 2005 056 952.8, filed on Nov. 29, 2005, the contents of which are herein incorporated by reference in their entirety.

### FIELD OF THE INVENTION

The invention relates to a circuit arrangement and a method for generating local oscillator signals. The invention also relates to a phase locked loop having the circuit arrangement and to a use for the circuit arrangement.

### BACKGROUND OF THE INVENTION

Many present-day standards for wireless communication use methods which are based on transmission on a plurality of carrier frequencies. An example of these are Wireless Local Area Network, WLAN, or as fourth-generation standard, Multiband Orthogonal Frequency Division Multiplexing Ultra-Wideband, MB-OFDM UWB. In this modern standard, various frequency bands with the same bandwidth are available for a transmission channel. The distribution of the frequencies which is prescribed for the MB-OFDM UWB standard is shown in FIG. 7. In this case, five band groups BG1 to BG5 are available. Band groups BG1 to BG4 respectively contain three frequency bands, and band group BG5 contains two frequency bands. I/Q mixers, in directly converting transmission and reception devices, require frequency signals at the frequencies of the respectively used band, for example 3432 MHz for band #1. In the case of a directly converting transmission and reception device, the data to be transmitted are processed without conversion to an intermediate frequency before transmission and after reception. To this end, the frequency signals need to be in the form of I/Q signals, i.e. in the form of an inphase component, I component, and a quadrature component, Q component. The use of MB-OFDM UWB can be used as a substitute for wired connections, such as Universal Serial Bus, USB, or Firewire or else for wireless communication, e.g. using WLAN or Bluetooth. Suitable places of use include workstation computers, printers, personal digital assistants, PDAs, MP3 players or mobile telephones, in which MB-OFDM UWB is used as a further communication means in addition to an existing telecommunication standard.

In principle, all frequency bands in all band groups can be used, with the flexibility of a device increasing with the number of useable frequency bands. However, frequency signals need to be generated for all desired frequency bands, which has an associated high level of complexity.

For example, frequency signals for a plurality of frequency bands can be generated using a reference frequency signal and two phase locked loops with the aid of a single sideband mixer.

In single sideband mixing, SSB mixing, two frequency signals are processed such that the signal frequency of the resultant signal is obtained from the sum of or the difference between the signal frequencies of the input signals.

Using the methods described, it can be a complex matter to generate as many frequency signals as possible from as many frequency bands and band groups as possible. Either it is only possible to generate frequency signals for a few frequency bands or generation requires the use of a large number of phase locked loops, which require space in a circuit and increase the power consumption of the circuit.

### BRIEF DESCRIPTION OF THE DRAWINGS

The invention is explained in detail below using exemplary embodiments with reference to the drawings in which

FIG. 1A shows a first exemplary embodiment of a circuit arrangement for generating local oscillator signals,

FIG. 1B shows a second exemplary embodiment of a circuit arrangement for generating local oscillator signals,

FIG. 2 shows a third exemplary embodiment of a circuit arrangement for generating local oscillator signals,

FIG. 3 shows a first exemplary embodiment of an auxiliary signal generator,

FIG. 4 shows a second exemplary embodiment of an auxiliary signal generator,

FIG. 5 shows an exemplary embodiment of a phase locked loop,

FIG. 6 shows an exemplary embodiment of an application for a circuit arrangement for generating local oscillator signals in a transceiver device,

FIG. 7 shows a frequency band distribution based on the MB-OFDM UWB standard.

### DETAILED DESCRIPTION OF THE INVENTION

In the following description further aspects and embodiments of the present invention are summarized. In addition, reference is made to the accompanying drawings, which form a part hereof, and in which is shown by way of illustration, in which the invention may be practiced. The embodiments of the drawings present a description in order to provide a better understanding of one or more aspects of the present invention. This description is not intended to limit the features or key-elements of the invention to a specific embodiment. Rather, the different elements, aspects and features disclosed in the embodiments can be combined in different ways by a person skilled in the art to achieve one or more advantages of the present invention. It is to be understood that other embodiments may be utilized and structural or logical changes may be made without departing from the scope of the present invention. The elements of the drawing are not necessarily to scale relative to each other. Like reference numerals designate corresponding similar parts.

In one exemplary embodiment, a circuit arrangement for generating local oscillator signals is provided which comprises a signal input for supplying a reference frequency signal at a first operating frequency and a signal output for tapping off a local oscillator signal.

In addition, the circuit arrangement has at least one frequency divider which can be used to derive a second signal at a second operation frequency from the reference frequency signal. Furthermore, the circuit arrangement comprises a selection device having a first input which is coupled to the signal input, a second input which is coupled to the output of the frequency divider, an output and a control input. The control input is configured to couple the first or the second input of the selection device to its output on the basis of a signal on the control input. The circuit arrangement also has an auxiliary signal generator for generating a single auxiliary signal at an auxiliary frequency, where the auxiliary signal is derived from the reference frequency signal. The auxiliary signal generator has a control input for selecting the auxiliary frequency from a plurality of available auxiliary frequencies. In addition, the circuit arrangement comprises a frequency conversion device having a first signal input which is coupled to the output of the selection device, a second signal input which is coupled to the output of the auxiliary signal generator, and a signal output which is configured to output the local oscillator signal derived from the signals which are applied to the input side.

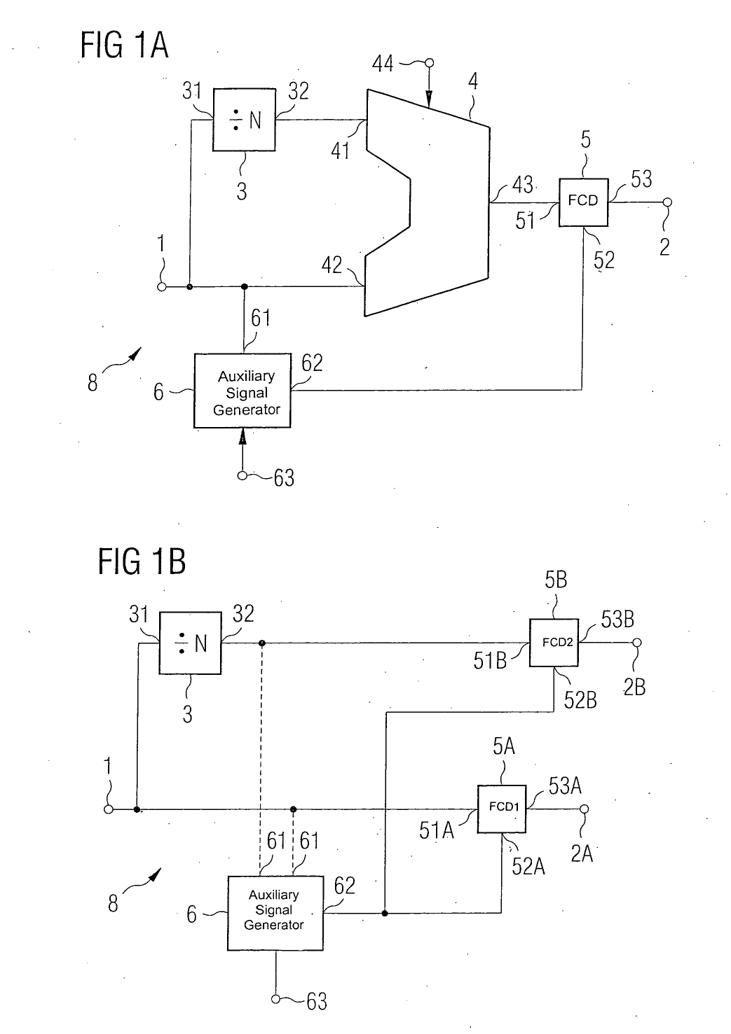

FIG. 1A shows an embodiment of a circuit arrangement 8 which comprises a signal input 1, a frequency divider 3 and a selection device 4. The input 31 of the frequency divider 3 and the first input 42 of the selection device 4 are coupled to the signal input 1. A second input 41 of the selection device 4 is coupled to an output 32 of the frequency divider 3. The selection device 4 also has a control input 44 and a signal output 43 which is coupled to a first signal input 51 of a frequency conversion device (FCD) 5. An auxiliary signal generator 6 has an input 61, which is coupled to the signal input 1, and also an output 62, which is coupled to a second signal input 52 of the frequency conversion device 5. In addition, the auxiliary signal generator 6 comprises a control input 63. The output 53 of the frequency conversion device 5 is coupled to the signal output 2 of the circuit arrangement 8.

In one embodiment the signal input 1 is used to supply the circuit arrangement 8 with a reference frequency signal at a first operating frequency. The frequency divider 3 takes the reference frequency signal and derives a signal at a second operating frequency, which is obtained as the first operating frequency of the reference frequency signal divided down by the factor N.

On the basis of a control signal which is applied to the control input 44 of the selection device 4, in one embodiment the selection device 4 outputs to the output 43 either the reference frequency signal which is applied to the first input 42 or the second signal at the second operating frequency, which is applied to the second input 41.

In the auxiliary signal generator 6, a single auxiliary signal is derived from the reference frequency signal which is applied to the input 61 in one embodiment. The auxiliary signal may have different signal frequencies. A control signal which is supplied via the control input 63 selects which of the signal frequencies is output at the output 62 of the auxiliary signal generator 6.

From the two signals which are applied to the input 51 and to the input 52 of the frequency conversion device 5, a local oscillator signal is derived whose signal frequency is obtained from the sum of or the difference between the signal frequencies of the applied signals. The local oscillator signal can be tapped off at the signal output 2.

To generate local oscillator signals at frequencies for the frequency bands based on the MB-OFDM UWB standard, in one embodiment, a signal at a frequency from the frequency range of a band group may be provided at the input 51 and an auxiliary signal may be provided at the second input 52. In this case, the choice of a frequency for the auxiliary signal can be used to determine the frequency of the local oscillator signal such that it corresponds to the frequency of a frequency band within the band group. This means that the frequency of the local oscillator signal is selected by means of the decision for a band group in the selection device 4 and by means of the decision for a specific frequency band in the band group in the auxiliary signal generator 6. The selection options for the band groups are dependent on the choice of frequency for the reference frequency signal and on the choice of division ratio N for the frequency divider 3.

In one embodiment the local oscillator signal can be generated from the signals applied to the inputs 51 and 52 in the frequency conversion device 5 using single sideband mixing. When mixing two sinusoidal signals, a signal is usually generated which, in a spectral consideration, has frequency components at the sum of and the difference between the frequencies of the signals which are to be mixed. However, a single sideband mixer eliminates the unwanted frequency component, that is to say the frequency component at the sum of or the frequency component at the difference between the frequencies, for example by means of filtering. In this case, reference is also made to mixers which reject image frequency signals, called image rejection mixers.

Since the circuit arrangement 8 in one embodiment derives both the signal at the second operating frequency and the auxiliary signals from the one reference frequency signal, an oscillator which provides the reference frequency signal is sufficient. In addition, in one embodiment the principle described can be used to generate local oscillator signals for a plurality of frequency bands in a plurality of band groups.

FIG. 1B shows another exemplary embodiment of a circuit arrangement for generating local oscillator signals. The circuit arrangement 8 comprises a signal input 1, a frequency divider 3 and a first and a second frequency conversion device 5A, 5B (FCD1, FCD2). The signal input 1 is coupled to a first input 51A of the first frequency conversion device 5A. Accordingly, an output 32 of the frequency divider 3 is coupled to a first input 51B of the second frequency conversion device 5B. An auxiliary signal generator 6 has an input 61 which can be coupled to the signal input 1 or to the output 32 of the frequency divider 3. In addition, the auxiliary signal generator 6 comprises an output 62 which is coupled to a respective second signal input 52A, 52B of the first and second frequency conversion devices 5A, 5B. Furthermore, the auxiliary signal generator 6 comprises a control input 63. The outputs 53A, 53B of the frequency conversion devices 5A, 5B are coupled to respective signal outputs 2A, 2B of the circuit arrangement 8.

In one embodiment the signal input 1 is used to supply the circuit arrangement 8 in turn with a reference frequency signal at a first operating frequency. The frequency divider 3 takes the reference frequency signal and derives a signal at a second operating frequency, which is obtained as the first operating frequency of the reference frequency signal divided down by the factor N.

Accordingly, in one embodiment the auxiliary signal generator 6 generates a single auxiliary signal which can have different signal frequencies. A control signal which is supplied via the control input 63 selects which of the signal frequencies is output at the output 62 of the auxiliary signal generator 6. During generation of the auxiliary signal, digitally stored signal values can be converted into the analog auxiliary signal on the basis of the reference frequency signal or of a signal derived from the reference frequency signal, in one embodiment.

In one embodiment the two respective signals which are applied to the input 51A, 51B and to the input 52A, 52B of the frequency conversion devices 5A, 5B are used to derive a first and a second local oscillator signal, whose signal frequencies are obtained from the sum of or the difference between the signal frequencies of the applied signals. The local oscillator signals can be tapped off on the signal outputs 2A, 2B.

So as again to generate local oscillator signals at frequencies for the frequency bands based on the MB-OFDM UWB standard, for example, a signal at a frequency from the frequency range of a first band group may be provided at the input 51A of the first frequency conversion device 5A and an auxiliary signal may be provided at the second input 52. Similarly, a signal at a frequency from the frequency range of a second band group may be provided at the input 51B of the second frequency conversion device 5B and the auxiliary signal may be provided at the second input 52. In this embodiment, the choice of frequency for the auxiliary signal can be used to determine the frequency of the local oscillator signals such that it corresponds to the frequency of a frequency band within the respective band group. By way of example, the first and the second local oscillator signal may be associated with a respective band group.

In one embodiment the local oscillator signal can again be generated in the frequency conversion devices 5A, 5B using single sideband mixing.

In one embodiment the signal outputs 2A, 2B may have a selection device coupled downstream of them whose operation corresponds to that of the selection device 4 shown in FIG. 1A. It is thus again possible to select one of the first and second local oscillator signals on the basis of a further selection signal.

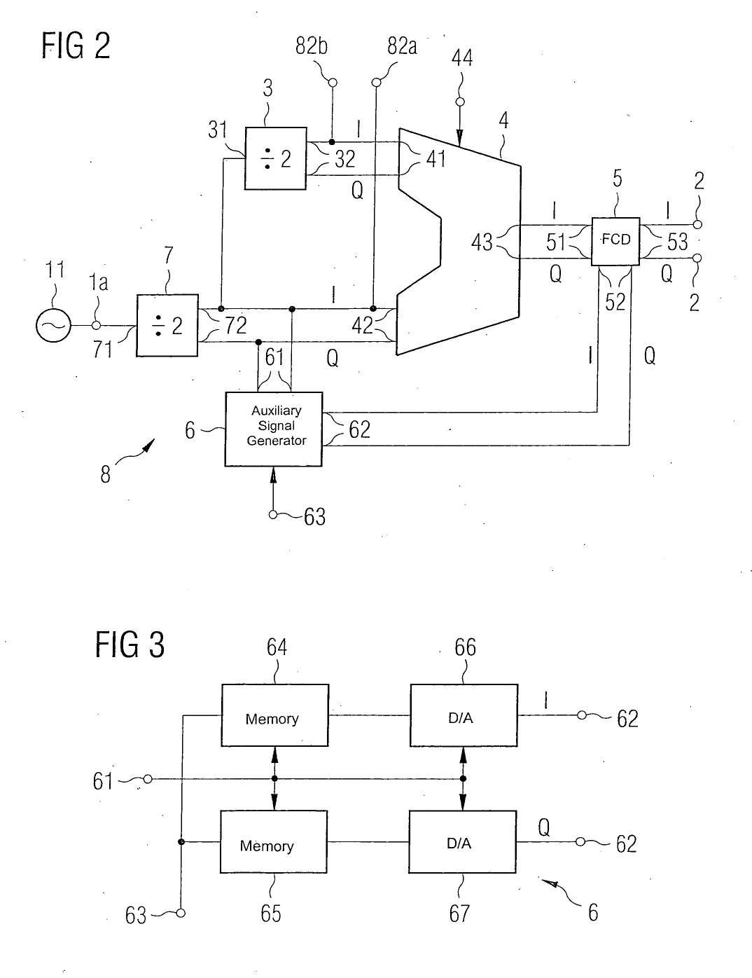

Another exemplary embodiment is shown in FIG. 2. The symbols I and Q used in the subsequent drawings are used only to identify that signals in the form of I/Q components are being carried at the appropriate points. They are not to be understood as reference symbols and serve merely a clarifying purpose. The signals occurring in the exemplary embodiment shown in FIG. 1B may also have I/Q components.

The input side of the circuit arrangement 8 is coupled to an oscillator 11 via a signal input 1a. Coupled to the signal input 1a is, a second frequency divider 7. The frequency divider 7 in one embodiment has a division ratio of two and is configured to output the divided-down signal in the form of I/Q components. The inphase component is supplied to the frequency divider 3, which likewise has a division ratio of two and outputs the signal at the second operating frequency in the form of I/Q components. The circuit arrangement 8 also has a signal tap 82a which is configured to tap off the I component of a signal applied to the input 42 of the selection device 4. A signal tap 82b is configured to tap off the I component of a signal applied to the second input 41 of the selection device 4. The auxiliary signal generator 6 is supplied with the I/Q components of the reference frequency signal from the frequency divider 7 via the input 61. The I/Q components of the selected auxiliary signal are output by the output 62 to the second input 52 of the frequency conversion device (FCD) 5. In one embodiment the first input 51 of the frequency conversion device 5 has the signal selected in the selection device 4 applied to it, likewise in the form of I/Q components.

The frequency conversion device 5 in one embodiment is in the form of a single sideband mixer. This can advantageously be used when mixing signals with I/Q components. By way of example, the single sideband mixer is configured such that the frequency of the mixed output signal is obtained from the sum of the frequencies of the input signals. This also applies to signals with I/Q components. If the quadrature component of a signal with I/Q components is inverted, that is to say undergoes phase rotation of 180°, however, then the signal altered in this manner acts like a signal at a negative frequency in the single sideband mixer. By supplying a conventional I/Q signal and an I/Q signal with an inverted quadrature component to the single sideband mixer, it is thus possible to generate an output signal at a frequency which is obtained from the difference between the frequency of the conventional I/Q signal and the frequency of the I/Q signal with the inverted quadrature component. By inverting the quadrature component, it is thus possible to use an auxiliary signal to generate two different target frequencies, that is to say frequencies of the output signal from the single sideband mixer.

To be able to provide a local oscillator signal at all frequencies based on the MB-OFDM UWB standard in band groups BG1 and BG3, for example, the inventive principle in one embodiment employs a single oscillator which delivers a signal at a frequency of 14784 MHz. The output of the frequency dividers 7 and 3 then generates I/Q signals at frequencies of 7392 MHz and 3696 MHz. A signal on the control input 44 can select one of these signals, which is then used as a basis for generating a local oscillator signal at one of the frequencies from a band group. In one embodiment, the signal on the control input 44 is used to select the desired band group.

In the auxiliary signal generator 6, auxiliary signals at frequencies of 264 MHz or 792 MHz are derived in one embodiment from the reference frequency signal at a frequency of 7192 MHz. A signal on the control input 63 of the auxiliary signal generator 6 selects which of these frequencies is applied to the output 62 and whether or not the quadrature component is output in inverted form. As a result, in one embodiment a single auxiliary signal at a frequency of +264 MHz, −264 MHz, +792 MHz or −792 MHz is selectively available. The output of the frequency conversion device 5, which in one embodiment is in the form of a single sideband mixer, can therefore provide local oscillator signals at the following frequencies:

For band group BG1:

f(Band #1)=3432 MHz=3696 MHz−264 MHz

f(Band #2)=3960 MHz=3696 MHz+264 MHz

f(Band #3)=4488 MHz=3696 MHz+792 MHz

For band group BG3:

f(Band #7)=6600 MHz=7392 MHz−792 MHz

f(Band #8)=7128 MHz=7392 MHz−264 MHz

f(Band #9)=7656 MHz=7392 MHz+264 MHz

It is thus possible in one embodiment to generate local oscillator signals at six different frequencies in two band groups using one oscillator and providing a single auxiliary signal at one of just two frequencies. This is done with little complexity in accordance with the invention and can be implemented in space-saving fashion by the circuit arrangement 8.

FIG. 3 shows an exemplary embodiment of an auxiliary signal generator 6 according to the invention. The auxiliary signal generator 6 has two memory elements 64 and 65 and two digital-analog converters 66 and 67, which are supplied with a clock signal via the input 61. The control input 63 is coupled to the memory elements 64 and 65. The input side of the digital-analog converters 66 and 67 is coupled to the memory elements 64 and 65, and the outputs 62 of the digital-analog converters output an auxiliary signal in the form of I/Q components.

The clock signal supplied to the auxiliary signal generator 6 can be the reference frequency signal in one embodiment. This is used to derive a memory clock and a sampling frequency for the digital-analog converters 66 and 67. The digitized oscillations stored in the memory elements 64 and 65 are converted into the analog auxiliary signal with I/Q components by the digital-analog converters 66 and 67.

By way of example, the memory element 64 stores digitized values for an I component, which are converted into an analog oscillation by the digital-analog converter 66, while the memory element 65 stores digitized values for a Q component, which are converted into the analog Q component by the digital-analog converter 67.

In this embodiment, the memory elements 64 and 65 store at least two different I/Q signals at different frequencies in digitized form, these signals being able to be selected by means of a signal on the control input 63. By way of example, signals at a frequency of 264 MHz and 792 MHz are stored in this embodiment.

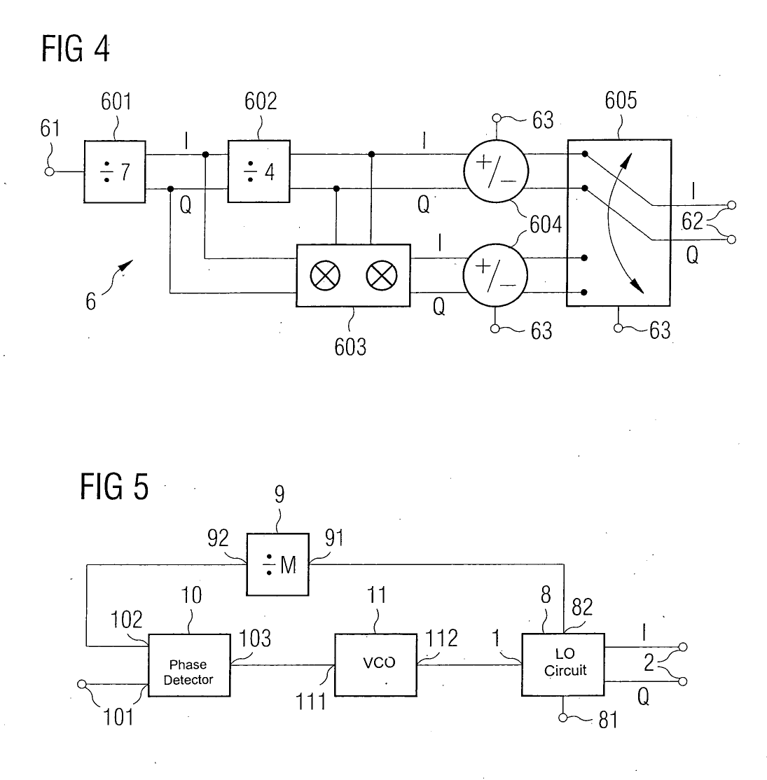

FIG. 4 shows another exemplary embodiment of an auxiliary signal generator 6. A frequency divider 601 with a division ratio of seven in one embodiment has its input side coupled to the input 61 of the auxiliary signal generator 6. Its output, which is configured to output I/Q components, has a frequency divider 602 with a division ratio of four in one embodiment and a single sideband mixer 603 coupled thereto. A second input of the single sideband mixer 603 is coupled to the output of the frequency divider 602. In addition, the output of the frequency divider 602 and the output of the single sideband mixer 603 are coupled by means of a respective phase inverter 604 to a selection device 605. The phase inverters 604 and the selection device 605 in one embodiment have a respective control input 63.

The input 61 of the auxiliary signal generator 6 can be supplied with the reference frequency signal, for example. This signal is at a frequency of 7392 MHz, in one embodiment. The output of the frequency divider 601 therefore generates an I/Q signal at a frequency of 1056 MHz. Following further frequency division by the frequency divider 604 by the factor four, an I/Q signal at a frequency of 264 MHz is generated. Mixing the signals with 1056 MHz and 264 MHz generates an I/Q signal at a frequency of 792 MHz at the output of the single sideband mixer. With an appropriate signal on the control input 63, the phase inverters 604 can invert the quadrature component of the signal, that is to say can phase-shift it through 180°. This means that the selection device 605 has auxiliary signals at a frequency of ±264 MHz and ±792 MHz for the selection, which is finally determined by means of the signal on the control input 63 in one embodiment.

FIG. 5 shows an exemplary embodiment of a phase locked loop based on the proposed principle with the circuit arrangement 8. The phase locked loop comprises the circuit arrangement 8, which has a signal input 1, a control input 81 and a signal tap 82. At the signal output 2, the circuit arrangement 8 outputs a local oscillator signal in the form of I/Q components. The signal tap 82 is coupled to the input 91 of a frequency divider 9 with a division ratio M. In addition, the phase locked loop comprises a phase detector 10 whose first input 101 is configured to supply a reference frequency signal and whose second input 102 is coupled to the output 92 of the frequency divider 9. The control output 103 of the phase detector 10 is coupled to an input 111 of a voltage controlled oscillator 11. The latter's output 112 is coupled to the signal input 1 of the circuit arrangement 8.

In one embodiment, the reference frequency signal on the input 101 of the phase detector 10 can be delivered directly by a crystal oscillator or is derived from the signal from a crystal oscillator via a voltage divider. The phase detector 10 compares this signal with the feedback signal on the input 102. To this end, both signals are ideally at the same frequency. Since the frequency of the signal on the signal tap 82 is normally significantly higher than that of the signal applied to the input 101, it is divided down to the appropriate value by means of the frequency divider 9 with the division ratio M. Frequency errors are corrected in the voltage controlled oscillator 11 by a signal at the control output 103. By way of example, the signal tap 82 is coupled to the frequency tap 82a, as can be seen in FIG. 2, which means that a signal at a frequency of 7392 MHz is returned. If the phase detector is connected directly to a commercially available crystal oscillator at a frequency of 19.2 MHz then the frequency divider 9 requires an integer division ratio of M=385 in order to match the frequency of the return signal to the 19.2 MHz.

In one embodiment the use of a commercially available crystal oscillator involves a number of advantages. Since crystal oscillators are required in many applications, such as in mobile radio technology, they are generated in large numbers and are therefore available cheaply.

Another advantage is when a crystal oscillator is used in other parts of a circuit and it is possible to use this crystal oscillator, for example the crystal oscillator in a mobile telephone.

The control input 81, which in one embodiment is coupled internally to the control input 44 and to the control input 63, can be used to select a band group and a frequency within the band group, that is to say the frequency of the local oscillator signal. The frequency of the returned signal on the signal tap 82 is not influenced thereby.

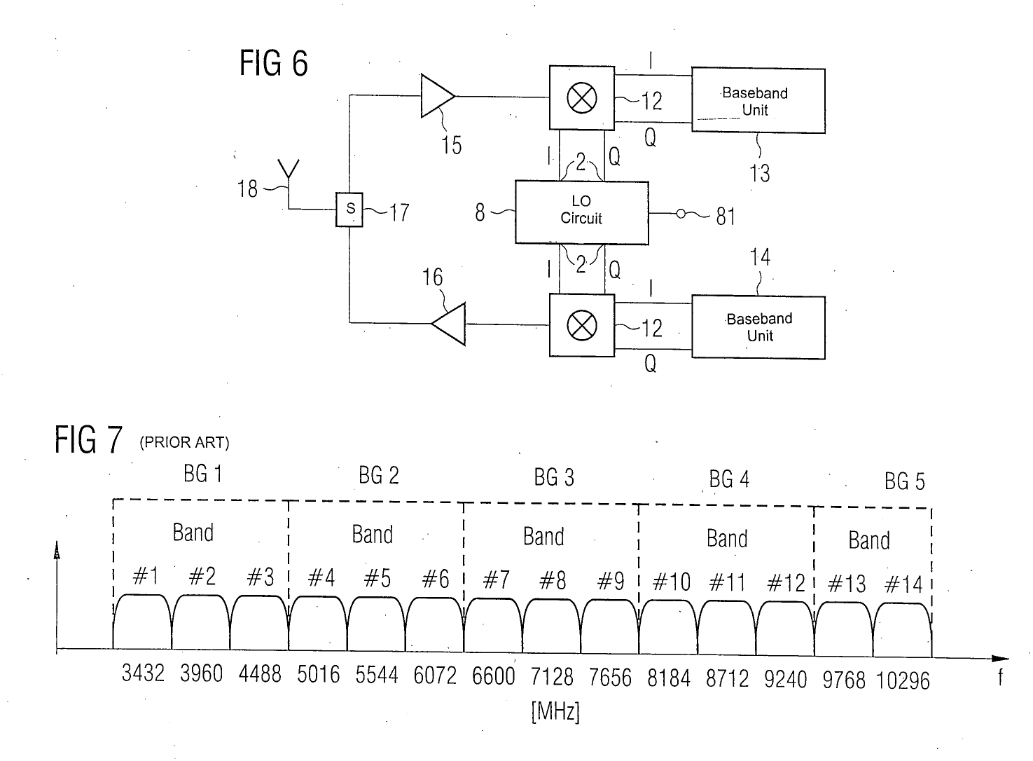

FIG. 6 shows an exemplary embodiment of an application for the circuit arrangement 8 in a transmission and reception device. The transmission and reception device comprises a baseband unit 14 for the transmission path, wherein the output side of the baseband unit is coupled to an I/Q mixer 12. The circuit arrangement 8 uses the signal output 2 to supply the local oscillator signal to the I/Q mixer 12 in the form of I/Q components. The mixed signal is supplied to the antenna 18 via an amplifier 16, which is in the form of a power amplifier, and an antenna changeover switch (S) 17 for broadcasting.

A signal received via the antenna 18 is forwarded via the antenna changeover switch 17 and the amplifier 15 to an I/Q mixer 12 in the reception path. The amplifier 15 in one embodiment is in the form of a low-noise preamplifier, called a low noise amplifier. The I/Q mixer 12 in the reception path is also supplied with the local oscillator signal in the form of I/Q components from the circuit arrangement 8. The mixed signal is processed in a baseband unit 13 in the reception path. The control input 81 can be used to select the frequency of the local oscillator signal.

The mixing in both the transmission path and the reception path is effected using a direct conversion method in one embodiment. In this embodiment, the data to be transmitted are converted directly, that is to say without conversion to intermediate frequencies, to a signal at the transmission frequency, or the received signal is converted directly into the received data. The antenna changeover switch 17 is used in one embodiment to isolate the transmission path from the reception path.

In another embodiment, a reference frequency signal from which a second signal and an auxiliary signal are derived is supplied to the circuit arrangement via the signal input. The reference frequency signal may be derived from a signal provided by a crystal oscillator, for example. The second signal is derived using a frequency divider, for example with a division factor of 2, so that the signal frequency of the second signal, that is to say the second operating frequency, is half the magnitude of the signal frequency of the reference frequency signal, that is to say the first operating frequency. In the selection device, a signal on the control input of the selection device can be used in one embodiment to select whether the reference frequency signal at the first operating frequency or the second signal at the second operating frequency is output to the output. In the auxiliary signal generator, an auxiliary signal is derived from the reference frequency signal. The auxiliary signal may be at different frequencies in one embodiment, the auxiliary signal also being able to be a DC signal at the frequency 0 Hz. In this embodiment too, a signal on a control input can be used to select which of the at least two frequencies is output at the output of the auxiliary signal generator. In the frequency conversion device, the local oscillator signal is derived from the selected signal at the output of the selection device and from the selected auxiliary signal. In one embodiment, the local oscillator signal can be derived using single sideband mixing if the frequency conversion device is in the form of a single sideband mixer.

Deriving the local oscillator signal in the circuit arrangement requires only the supply of a single signal as a reference frequency signal in one embodiment, from which it is possible to derive all further required frequency signals. This means that there is no need for any elements which generate signals at additional frequencies, which advantageously results in a low space requirement and a low power consumption for the circuit arrangement.

In another exemplary embodiment, the circuit arrangement has a second frequency divider coupled upstream of the signal input of the circuit arrangement. In one embodiment this is used to derive the reference frequency signal at the first operating frequency from a signal which is applied to the input of the second frequency divider. Hence, if there is initially only a signal at a signal frequency higher than the first operating frequency available, the reference frequency signal can be derived from the signal by the second frequency divider.

In another exemplary embodiment, the circuit arrangement has a device which is configured to break down a local oscillator signal into I/Q components coupled downstream of the signal output of the circuit arrangement.

If a circuit requires a local oscillator signal having I/Q components, the I/Q components can be derived in one embodiment from the local oscillator signal by the device. In the case of I/Q components, the Q component is phase-shifted relative to the I component, by 90° in one embodiment.

The device for breaking down the local oscillator signal into I/Q components may be in the form of a frequency divider in one embodiment. If a local oscillator signal in the form of I/Q components is required, it is very simple to provide these at the output of a frequency divider. Since the frequency of the output signal from the frequency divider is lower than the frequency of the local oscillator signal in this case, this needs to be taken into account when selecting the frequencies in the circuit arrangement.

In another embodiment, the output of the at least second frequency divider is configured to output I/Q components. This means that both the reference frequency signal and the second signal at the second operating frequency and the auxiliary signals can be extended and processed further as I/Q components. The local oscillator signal at the output of the circuit arrangement can also be output in the form of I/Q components.

In another exemplary embodiment, the auxiliary signal generator comprises at least one memory element and at least one digital-analog converter. By way of example, the memory element may be in the form of a signal ROM. The values stored in the memory element may be samples of a sinusoidal signal, for example, which are converted into an analog sinusoidal signal by the digital-analog converter. A clock signal which is required for operating the memory element and the digital-analog converter may be the reference frequency signal or a signal derived there from. The output signal from the auxiliary signal generator can be output in the form of I/Q components. To be able to provide auxiliary signals at various frequencies, in one embodiment the memory element stores a plurality of sets of samples for the various frequencies. The auxiliary signal or the frequency is selected by means of a selection signal on the control input of the auxiliary signal generator.

In one alternative exemplary embodiment, the auxiliary signal generator comprises at least one frequency divider and at least one single sideband mixer. By way of example, a frequency divider and a single sideband mixer can generate two auxiliary signals whose frequencies are obtained from the sum of or the difference between the first operating frequency and the divided-down frequency. If the auxiliary signal generator comprises a plurality of frequency dividers, it is first of all possible to derive signals at various divided-down frequencies and to make these available as auxiliary signals directly or via the mixing using the single sideband mixer. A respective one of the auxiliary signals is output by the auxiliary signal generator at its output on the basis of the signal applied to its control input.

In one exemplary embodiment, a phase locked loop having a circuit arrangement in accordance with one of the embodiments described additionally comprises a phase detector and a voltage controlled oscillator. The phase detector has a first input for supplying a reference frequency signal, a second input for supplying a feedback signal and a control output. The voltage controlled oscillator is arranged such that its input is coupled to the control output of the phase detector and its output is coupled to the signal input of the circuit arrangement. In addition, the circuit arrangement has a signal tap which is coupled to the second input of the phase detector via a frequency divider. The division ratio of this frequency divider may be adjustable in one embodiment.

The reference frequency signal can be supplied to a phase detector by a crystal oscillator directly or in the form of a signal which has been divided down by a frequency divider. In the phase detector, a signal which has been returned by the circuit arrangement can be compared with the reference frequency signal in one embodiment, which regulates the voltage of the voltage controlled oscillator. The reference frequency signal of the circuit arrangement corresponds to the output signal from the voltage controlled oscillator or is derived from this output signal. On account of the frequency divider in the feedback path, which divides down the frequency of the signal tapped off in the circuit arrangement to form the feedback signal, the frequency of the reference frequency signal may be significantly lower than that of the reference frequency signal in the circuit arrangement.

Since no further phase locked loop is required for generating the local oscillator signals at the various frequencies, the arrangement of the phase locked loop having the circuit arrangement can be implemented in space-saving fashion and is distinguished by a low power consumption in one embodiment.

The signal tap in the circuit arrangement for returning a frequency signal can be coupled to a plurality of points within the circuit arrangement. In one embodiment, the signal tap may be coupled to the first or to the second input of the selection device. Alternatively, the signal tap may be coupled to the signal input of the circuit arrangement. It is also possible in one embodiment for the connecting point for the signal tap to be provided so as to be able to change it over during operation. Similarly, it is possible for the division ratio of the frequency divider in the feedback path of the phase locked loop to be adjusted or altered during operation. This normally results in the frequency of the reference frequency signal being altered.

In one exemplary embodiment of a method for generating local oscillator signals, a reference signal at a first operating frequency is provided. A second signal at a second operating frequency is derived from the reference frequency signal by means of frequency division. The reference signal or the second signal is selected as principal signal on the basis of a first selection signal. A single auxiliary signal at a first frequency or an at least second frequency is generated on the basis of a second selection signal. A local oscillator signal is generated by mixing the principal signal and the auxiliary signal. The mixing can be done in the form of a single sideband modulation in one embodiment. When the auxiliary signal is generated, digitally stored signal values can be converted into the analog auxiliary signal on the basis of the reference frequency signal, for example.

In one embodiment this case, both the principal signal and the ancillary signal are advantageously derived from the one reference frequency signal provided. No further frequency signals are required, which would need to be supplied additionally.

In another exemplary embodiment of the method, providing the reference frequency signal involves providing a signal from which the reference frequency signal is derived by means of a frequency divider.

In another embodiment of the method, the local oscillator signal has I/Q components. In this case, the Q component ideally has a phase offset of 90° relative to the I component. Similarly, the reference frequency signal and all signals derived from the reference frequency signal may have I/Q components in the method.

In one alternative exemplary embodiment of a method for generating local oscillator signals, a reference signal at a first operating frequency is provided. A second signal at a second operating frequency is derived from the reference frequency signal by means of frequency division. A single auxiliary signal at a first frequency or an at least second frequency is generated on the basis of a selection signal by means of digital-analog conversion of digitally stored signal values. A first local oscillator signal is generated by mixing the reference frequency signal and the auxiliary signal. Accordingly, a second local oscillator signal is generated by mixing the second signal and the auxiliary signal. The mixing can be done in the form of single sideband modulation in one embodiment. During generation of the auxiliary signal, digitally stored signal values can be converted into the analog auxiliary signal on the basis of the reference frequency signal, for example. Both the auxiliary signal and the reference frequency signal and all signals derived from the reference frequency signal may have inphase and quadrature components in one embodiment.

In one of the embodiments described, the circuit arrangement can be used in a directly converting transmission and reception device.

The various embodiments can be combined without this conflicting with the essence of the invention. In particular, the frequency generation is not limited to the frequencies indicated in the exemplary embodiments, but rather the principle described extends to all application areas in which local oscillator signals for a plurality of frequency bands need to be generated with little complexity.

Although specific embodiments have been illustrated and described herein, it will be appreciated by those of ordinary skill in the art, that any arrangement which is calculated to achieve the same purpose may be substituted for the specific embodiments shown. It is to be understood, that the above description is intended to be illustrative and not restrictive. This application is intended to cover any adaptations or variations of the invention. Combinations of the above embodiments and many other embodiments will be apparent to those of skill in the art upon reading and understanding the above description. The scope of the invention includes any other embodiments and applications in which the above structures and methods may be used. The scope of the invention should, therefore, be determined with reference to the appended claims along with the scope of equivalents to which such claims are entitled.

It is emphasized that the Abstract is provided to comply with 37 C.F.R. section 1.72(b) requiring an abstract that will allow the reader to quickly ascertain the nature and gist of the technical disclosure. It is submitted with the understanding, that it will not be used to interpret or limit the scope or meaning of the claims.

1. A circuit arrangement for generating local oscillator signals, comprising:
a signal input configured to receive a reference frequency signal at a first operating frequency;
a signal output configured to output a local oscillator signal;
at least one frequency divider configured to derive a second signal at a second operating frequency from the reference frequency signal;
a selection device having a first input coupled to the signal input, a second input coupled to the output of the frequency divider, an output and a control input, wherein the selection device is configured to couple the first or the second input to the output based on a first selection signal on the control input;
an auxiliary signal generator configured to generate at an output thereof a single auxiliary signal at one of a plurality of available frequencies based on a second selection signal, wherein the auxiliary signal is derived from the reference frequency signal; and
a frequency conversion device having a first signal input coupled to the output of the selection device, a second signal input coupled to the output of the auxiliary signal generator, and an output configured to output the local oscillator signal derived from the signals which are applied to the first and second signal inputs.

2. The circuit arrangement of claim 1, wherein the auxiliary signal generator comprises at least one memory element and at least one digital-analog converter.

3. The circuit arrangement of claim 1, wherein the frequency conversion device comprises a single sideband mixer.

4. The circuit arrangement of claim 1, wherein the signal input of the circuit arrangement has at least one second frequency divider coupled upstream thereof configured to derive the reference frequency signal at the first operating frequency from a signal which is applied to the input of the at least second frequency divider.

5. The circuit arrangement of claim 4, wherein the at least one second frequency divider is configured to output inphase and quadrature components.

6. The circuit arrangement of claim 1, wherein the signal output of the circuit arrangement has a device coupled downstream thereof configured to output inphase and quadrature components.

7. A circuit arrangement for generating local oscillator signals, comprising
a signal input configured to receive a reference frequency signal at a first operating frequency;
a frequency divider configured to derive a second signal at a second operating frequency from the reference frequency signal;
an auxiliary signal generator configured to generate at an output thereof a single auxiliary signal at one of a plurality of available auxiliary frequencies based on a selection signal, wherein the auxiliary signal generator comprises at least one memory element and at least one digital-analog converter;
a first frequency conversion device comprising a first input coupled to the signal input, a second input coupled to the output of the auxiliary signal generator, and an output, wherein the first frequency conversion device is configured to output a first local oscillator signal derived from the signals which are applied to the first and second inputs thereof; and
a second frequency conversion device comprising a first input coupled to an output of the frequency divider, a second input coupled to the output of the auxiliary signal generator, and an output configured to output a second local oscillator signal derived from the signals which are applied to the first and second inputs thereof.

8. The circuit arrangement of claim 7, wherein the auxiliary signal is derived using data within the memory element.

9. The circuit arrangement of claim 7, wherein the first or the second frequency conversion device, or both, comprise a single sideband mixer.

10. The circuit arrangement of claim 7, further comprising a selection device comprising inputs coupled to the respective output of the first and second frequency conversion devices, and configured to output the first or the second local oscillator signal based on a further selection signal supplied thereto.

11. The circuit arrangement of claim 7, wherein the circuit arrangement is configured to process signals with inphase and quadrature components.

12. A phase locked loop, comprising:
a local oscillator signal generating circuit, comprising:
a signal input configured to receive a reference frequency signal at a first operating frequency;
a signal output configured to output a local oscillator signal;
at least one frequency divider configured to derive a second signal at a second operating frequency from the reference frequency signal;
a selection device having a first input coupled to the signal input, a second input coupled to the output of the frequency divider, an output and a control input, wherein the selection device is configured to couple the first or the second input to the output based on a first selection signal on the control input;
an auxiliary signal generator configured to generate at an output thereof a single auxiliary signal at one of a plurality of available frequencies based on a second selection signal, wherein the auxiliary signal is derived from the reference frequency signal; and
a frequency conversion device having a first signal input coupled to the output of the selection device, a second signal input coupled to the output of the auxiliary signal generator, and an output configured to output the local oscillator signal derived from the signals which are applied to the first and second signal inputs;
a phase detector comprising a first input configured to receive a reference frequency signal, a second input configured to receive a feedback signal, and a control output;
a voltage controlled oscillator comprising an input coupled to the control output of the phase detector, and comprising an output coupled to the signal input of the local oscillator signal generating circuit;
wherein the local oscillator signal generating circuit comprises a signal tap coupled to the second input of the phase detector via a frequency divider.

13. The phase locked loop of claim 12, wherein the frequency divider comprises an adjustable division ratio.

14. The phase locked loop of claim 12, wherein the signal tap of the local oscillator signal generating circuit is coupled to the first input of the selection device.

15. The phase locked loop of claim 12, wherein the signal tap is coupled to the second input of the selection device.

16. The phase locked loop of claim 12, wherein the signal tap is coupled to the signal input of the local oscillator signal generating circuit.

17. A method for generating local oscillator signals, comprising:
providing a reference frequency signal at a first operating frequency;
deriving a second signal at a second operating frequency from the reference frequency signal;
selecting the reference frequency signal or the second signal as a principal signal based on a first selection signal;
generating a single auxiliary signal at one of a plurality of available auxiliary frequencies based on a second selection signal; and
generating a local oscillator signal by mixing the principal signal and the auxiliary signal.

18. The method of claim 17, wherein generating the auxiliary signal comprises converting stored digital signal values into the analog auxiliary signal.

19. The method of claim 18, wherein the stored digital signal values are converted based on the reference frequency signal.

20. The method of claim 17, wherein the mixing comprises single sideband modulation.

21. The method of claim 17, wherein providing the reference frequency signal comprises deriving the reference frequency signal from a provided signal by means of frequency division.

22. The method of claim 17, wherein the generated local oscillator signal comprises an inphase component and a quadrature component.

23. The method of claim 17, wherein the reference frequency signal and all signals derived from the reference frequency signal comprise inphase and quadrature components.

24. A method for generating local oscillator signals, comprising:
providing a reference frequency signal at a first operating frequency;
deriving a second signal at a second operating frequency from the reference frequency signal;
generating a single auxiliary signal at one of a plurality of available auxiliary frequencies based on a selection signal by means of digital-analog conversion of stored digital signal values;
generating a first local oscillator signal by mixing the reference frequency signal and the auxiliary signal; and
generating a second local oscillator signal by mixing the second signal and the auxiliary signal.

25. The method of claim 24, wherein the stored digital signal values are converted based on the reference frequency signal.

26. The method of claim 24, wherein the mixing comprises single sideband modulation.

27. The method of claim 24, wherein the auxiliary signal, the reference frequency signal and all signals derived from the reference frequency signal comprise inphase and quadrature components.
